(19) United States
(12) Patent Application Publication
(10) Pub. No.: US 2016/0223069 A1
(43) Pub. Date: Aug. 4, 2016

(54) GEAR ASSEMBLY

(71) Applicants: Enrico Di Stefano, Rivoli TO (IT); Martin Voegelin, Diegten (CH)

(72) Inventors: Enrico Di Stefano, Rivoli TO (IT); Martin Voegelin, Diegten (CH)

(73) Assignee: Aktiebolaget SKF, Goteborg (SE)

(21) Appl. No.: 15/010,217

(22) Filed: Jan. 29, 2016

(30) Foreign Application Priority Data
Jan. 29, 2015 (DE) 102015201501.7

(51) Int. Cl. F16H 57/025; F16H 1/02

(52) U.S. Cl. CPC F16H 57/025; F16H 1/02

(57) ABSTRACT

A gear assembly includes a housing element, at least one gearbox shaft disposed in the housing element for rotation about an axis of rotation, and a brake element. The gearbox shaft is concentrically connected to the brake element, and the brake element is mounted in the housing element and secured against rotation with respect to the housing element. The brake element includes at least two projecting bodies radially spaced from the axis of rotation, and the housing element includes at least four attachment locations. The at least two projecting bodies are connectable to at least two of the at least four attachment locations of the housing element, and the at least two projecting bodies are securable to a first set of the at least four attachment locations or to a second set of the at least four attachment locations, the second set being different than the first set.

### CROSS-REFERENCE

This application claims priority to German patent application no. 102015201501.7 filed on Jan. 29, 2015, the contents of which are fully incorporated herein by reference.

### TECHNOLOGICAL FIELD

The disclosure is directed to a gear assembly that includes at least one gearbox shaft rotatably disposed in a housing element. The gearbox shaft is concentrically connected to a brake element, and the brake element is disposed in the housing element so that it does not rotate with respect to the housing element and in a manner that allows brake torque to be transmitted by the brake element between the gearbox shaft and the housing element.

### BACKGROUND

Gear assemblies of the above-described type may be used in actuators, linear actuators, for example, in which a rotational movement must be translated into a linear movement. It is sometimes necessary to provide such gear assemblies with a brake, and the brake may theoretically be placed at any point of the powertrain where it can prevent an undesired or unwanted rotational movement of the assembly. A preferred location for the brake is the motor or the main threaded spindle. However, the amount of brake torque that will be generated and/or the rotational speed of the element to be braked and/or the installation space available all may affect the mounting location of the brake. When necessary, the brake can alternately be disposed on an intermediate shafts of the gear assembly. To date, however, the ability to change the mounting location of the brake has been greatly limited because conventional components require a bearing point (e.g., a bearing sleeve) in the housing element of the gear element.

If, as is common, the brake element is disposed directly on the housing element of the gear element at a fixed position, at least minimum required installation space for the brake will be available. However, this approach limits the ability to vary a transmission ratio of the gear element, which is often desirable.

### SUMMARY

One aspect of the disclosure is to configure a gear assembly of the above-described type in a manner that makes it possible, in a simple manner, to vary the configuration of a brake element within certain limits. This may allow the brake element to function in an optimal manner and at the same time keeps the overall design of the gear assembly compact. Furthermore, embodiments of the disclosure allow the gear element to be manufactured in a modular manner. Embodiments thus make it possible to dispose the brake element at different positions in the gear assembly or gear housing based on the desired transmission ratio.

In certain embodiments, the brake element is attached in a rotationally fixed manner in the housing element by using at least two attachment elements that are radially spaced from the axis of rotation. The attachment elements are fixable at corresponding attachment locations of the housing element. Significantly, more attachment locations are available on the housing element than the number of attachment elements, and this allows the brake element to be attached to the housing element in different positions with respect to the position of the axis of rotation.

The brake element preferably includes a housing from which the attachment elements radially protrude, and the housing preferably has an essentially hollow-cylindrical shape. The attachment elements and the housing are preferably configured one-piece.

The attachment elements are particularly preferably configured as projecting bodies or flanges or tabs that can be screwed or otherwise secured to the attachment locations to thereby secure the brake element to the housing element.

According to a preferred embodiment of the disclosure, two attachment elements and four or six attachment locations are provided. Thus in a simple manner the brake element or the braked shaft can be fixed in two or three different positions. Of course other numbers of attachment elements and/or attachment locations can be provided.

The attachment locations are preferably disposed on or in the housing element such that when the brake element is mounted at different ones of the attachment locations the position of the axis of rotation relative to another gear in the gear housing and/or a wall of the gear housing can be changed by at most 15 mm, preferably by at most 5 mm. Of course these values can also be chosen differently, but in any case this makes it possible to adapt desired gear ratios or gear translations in a simple manner.

The gearbox shaft can be supported with one of its axial ends in a bearing element. The bearing element may at least partially penetrate the brake element or may be disposed within the brake element and be attached in the housing element. For example, the bearing element can be a rolling-element bearing or a sliding bearing bush.

The disclosure thus makes it possible to configure a mechanical brake element so that it can be mounted in the housing element of the gear element in a simple and flexible manner.

The brake element, which preferably includes a cylindrical housing in which a brake element is guided and disposed, makes it possible to attach the brake element in different predetermined locations so that the position of the axis of rotation can be changed. This allows the gear assembly to be constructed in a modular manner and to be designed in a simple manner for different gear ratios.

Another aspect of the disclosure comprises a gear assembly that includes a housing, a gearbox shaft, and a brake element mounted in the housing and fixed against rotation with respect to the housing. The brake element includes a cylindrical receiving portion configured to receive an end of the gearbox shaft, and the brake element includes at least two projecting bodies spaced from the axis of rotation and projecting radially outward from the brake element. The housing includes at least four attachment locations, and the at least two projecting bodies are securable to a first set of the at least four attachment locations or to a second set of the at least four attachment locations, the second set not including any attachment location of the first set. The at least four attachment locations are disposed such, that when the at least two projecting bodies are secured to the first set of the at least four attachment locations, the axis of rotation is in a first position, and when the at least two projecting bodies are secured to the second set of the at least four attachment locations, the axis of rotation is in a second position offset from the first position by 15 mm or less.

The disclosed gear assembly is preferably used in actuators, particularly in linear actuators.

Thus the gear assembly can also be configured for different gear ratios in a simpler manner than before. Gear assembly can be manufactured having prespecified gear ratios. The shaft that is braked by the brake element can be supported in a bearing point that is formed in the brake element so that, as explained, this bearing point is also changed with different positioning of the brake element.

The brake element can then be mounted in the required position in a specific housing element. Here the required high precision for the distances of one shaft to another is ensured. With the precise fixing or assembly of the brake element the precise position of the axis of rotation is also fixed together with its bearing.

The mechanical brake element can be constructed in a compact manner, i.e., it has a housing in which the actual brake and also the bearing for an intermediate shaft are disposed.

### BRIEF DESCRIPTION OF THE DRAWINGS

An exemplary embodiment of the disclosure is depicted in the drawings:

FIG. 1 is an elevational view, partly in section, of a gear assembly including a housing element in which a plurality of gearbox shafts are rotatably supported, one of which is connected to a brake element.

FIG. 2 is a perspective view of the housing element of FIG. 1, open at the top, with the brake element disposed at a first installation location.

FIG. 3 is a plan view of the housing element of FIG. 2.

FIG. 4 is a plan view of the housing element of FIG. 2 with the brake element installed in a different installation location.

### DETAILED DESCRIPTION

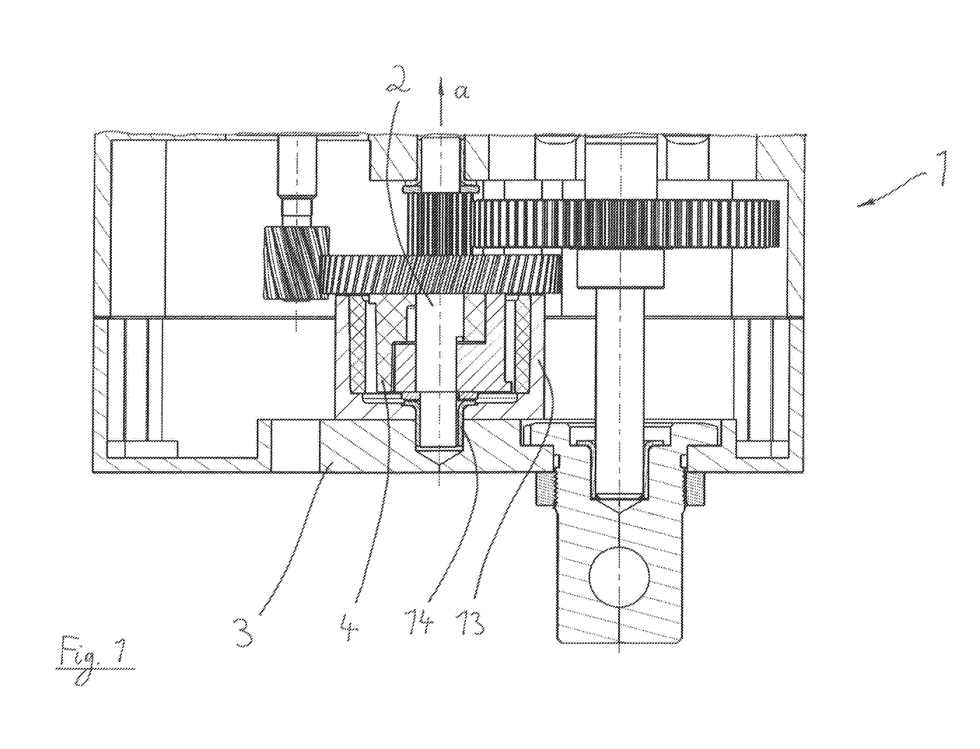

The principle construction of a gear assembly 1 is depicted in FIG. 1, partly in cross-section. The gear assembly 1 includes a housing element 3 in which a plurality of gearbox shafts are supported, which shafts are connected to one another via meshing gears. A gearbox shaft 2 is connected to a mechanical brake element 4, and braking the gearbox shaft 2 allows all the shafts in the gearbox to be braked as needed. The brake element 4 has a hollow-cylindrical housing 13. The gearbox shaft 2 is rotatable about an axis of rotation a and is supported with one of its axial ends in a bearing element 14. In the present embodiment, the bearing element 14 comprises a sliding bearing bush.

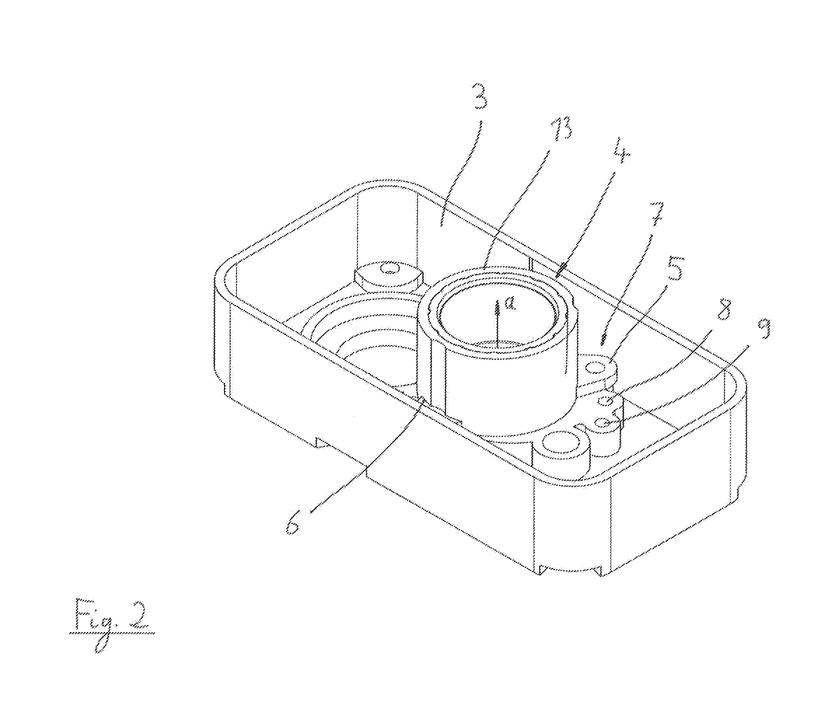

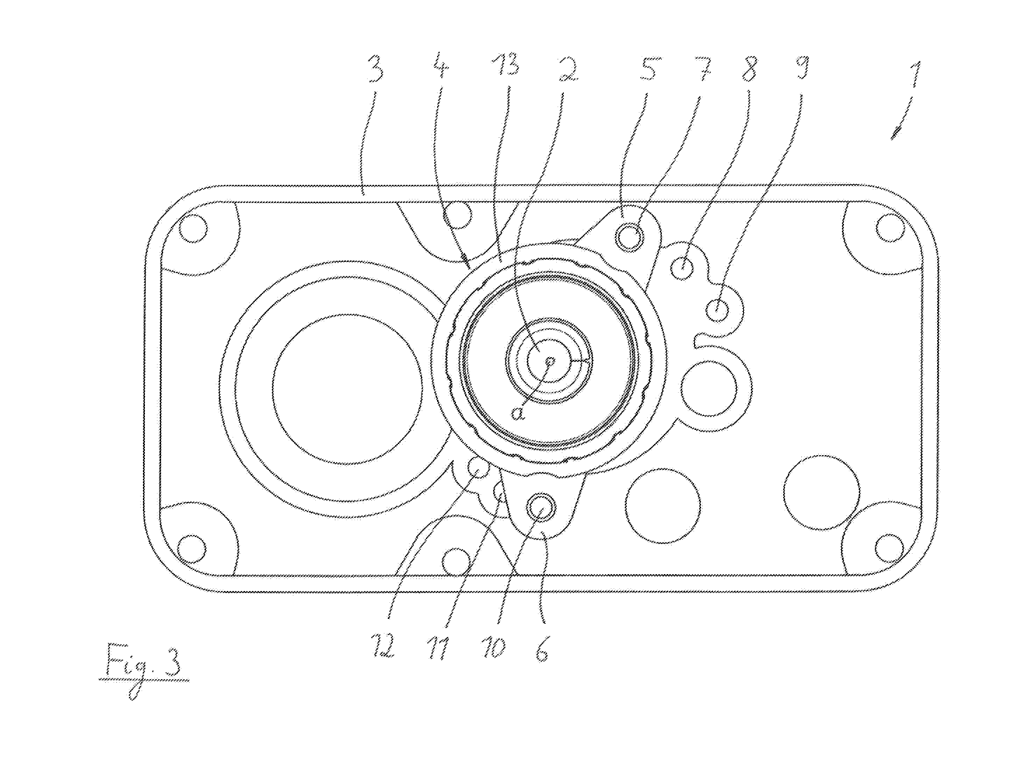

Further details regarding the arrangement of the brake element 4 in the housing element 3 are illustrated in FIGS. 2 to 4.

It can be seen in FIGS. 2-4 that the brake element 4 is provided with flange-type radially outwardly protruding tabs 5 and 6, sometimes referred to as attachment elements or projecting bodies. These tabs 5, 6 are configured so that they can be fixed, i.e. by screws, to pairs of the attachment locations 7, 8, 9, 10, 11, 12 in the housing element 3. In the present embodiment, the attachment locations are defined by holes formed in a support element in the housing. That is, the attachment of the brake element 4 in the housing element 3 in a rotationally fixed manner is effected by fixing the two tabs 5 and 6, which are spaced from the axis of rotation, at various pairs of the holes or attachment locations of the housing element.

It is important that the housing element 3 has more attachment locations 7, 8, 9, 10, 11, 12—in this case 6 attachment locations—than the number of tabs 5, 6. This allows the brake element 4 to be fixed on the housing element 3 with its axis of rotation (or the axis of rotation of a shaft supported in the brake element) in different positions relative to the axes of rotation of other shafts in the housing and/or relative to one or more walls of the housing element 3.

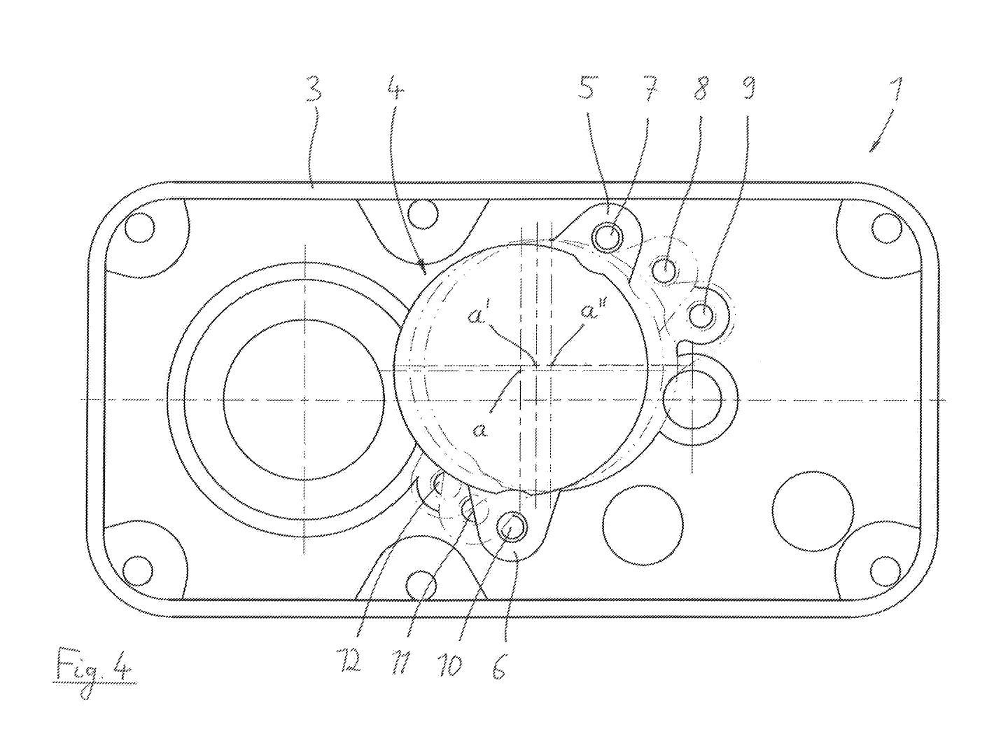

This is illustrated in FIG. 4 which shows the brake element 4 with its two tabs 5 and 6 (shown in solid lines) fixed to attachment locations 7 and 10 so that the axis of rotation a of a shaft supported in the brake housing 2 is in a first position relative to another shaft in the housing element 3 or to the walls of the housing element 3.

Meanwhile the dot-dashed lines in FIG. 4 show that the tabs 5 and 6 can also be fixed at a different pair of the attachment locations, e.g., at the attachment locations 8 and 11 or at the attachment locations 9 and 12.

When the tables 5 and 6 are secured at the attachment locations 8 and 11 the axis of rotation a′ is located in a second position different than that of the axis of rotation a when the tabs 5 and 6 are attached at attachment locations 7 and 10.

Correspondingly the tabs 5 and 6 can be mounted to the attachment locations 9 and 10 so that the axis of rotation a″ lies in yet a different position.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved gear assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Gear assembly

2 Gearbox shaft

3 Housing element

4 Brake element

5 Projecting body

6 Projecting body

7 Attachment location

8 Attachment location

9 Attachment location

10 Attachment location

11 Attachment location

12 Attachment location

13 Housing of the brake element

14 Bearing element

a Axis of rotation (first position)

a′ Second position of the axis of rotation

a″ Third position of the axis of rotation

What is claimed is:

1. A gear assembly comprising a housing element, at least one gearbox shaft disposed in the housing element for rotation about an axis of rotation, and a brake element, the gearbox shaft being concentrically connected to the brake element, the brake element being mounted in the housing element and secured against rotation with respect to the housing element,
wherein the brake element includes at least two projecting bodies radially spaced from the axis of rotation, and the housing element includes at least four attachment locations,
wherein the at least two projecting bodies are connectable to at least two of the at least four attachment locations of the housing element, and
wherein the at least two projecting bodies are securable to a first set of the at least four attachment locations or to a second set of the at least four attachment locations, the second set being different than the first set.

2. The gear assembly according to claim 1, wherein the brake element includes a housing and wherein each of the at least two projecting bodies comprises a tab protruding radially outwardly from the housing.

3. The gear assembly according to claim 2, wherein the housing includes a hollow-cylindrical portion.

4. The gear assembly according to claim 2, wherein the at least two projecting bodies and the housing are configured one-piece.

5. The gear assembly according to claim 2, wherein the at least two projecting bodies comprise first and second flanges.

6. The gear assembly according to claim 1, wherein the at least two projecting bodies are secured to the first set of the at least four attachment locations by screws.

7. The gear assembly according to claim 1, wherein the at least two projecting bodies consist of two tabs and the at least four attachment locations consist of six attachment locations.

8. The gear assembly according to claim 1, wherein the at least four attachment locations are disposed such that when the at least two projecting bodies are secured to the first set of the at least four attachment locations, the axis of rotation is in a first position and when the at least two projecting bodies are secured to the second set of the at least four attachment locations, the axis of rotation is in a second position offset from the first position by 15 mm or less.

9. The gear assembly according to claim 1, wherein the at least four attachment locations are disposed such that when the at least two projecting bodies are secured to the first set of the at least four attachment locations, the axis of rotation is in a first position and when the at least two projecting bodies are secured to the second set of the at least four attachment locations, the axis of rotation is in a second position offset from the first position by 5 mm or less.

10. The gear assembly according to claim 1, wherein an end of the gear shaft is supported in a bearing element that at least partially penetrates the brake element.

11. The gear assembly according to claim 1, wherein an end of the gear shaft is disposed within the brake element and is attached to the housing element.

12. The gear assembly according to claim 10, wherein the bearing element is a rolling-element bearing or a sliding bearing bush.

13. The gear assembly according to claim 1,
wherein the brake element includes a hollow-cylindrical housing and wherein the at least two projecting bodies are integral with and protrude radially outward from the housing,
wherein the at least two projecting bodies are secured to the at least four attachment locations by screws,
wherein the at least four attachment locations are disposed such that when the at least two projecting bodies are secured to the first set of the at least four attachment locations, the axis of rotation is in a first position and when the at least two projecting bodies are secured to the second set of the at least four attachment locations, the axis of rotation is in a second position offset from the first position by 5 mm or less, and
wherein an end of the gear shaft is supported in a bearing element that at least partially penetrates the brake element.

14. The gear assembly according to claim 1, wherein the at least two projecting bodies and the at least four attachment locations are configured such that the brake element must be rotated and translated to move the at least two projecting bodies from the first set of the at least four attachment locations to the second set of the at least four attachment locations.

15. The gear assembly according to claim 1, wherein the second set does not include any attachment locations of the first set.

16. A gear assembly comprising:
a housing,
a gearbox shaft, and
a brake element mounted in the housing and fixed against rotation with respect to the housing, the brake element including a cylindrical receiving portion configured to receive an end of the gearbox shaft, the brake element including at least two projecting bodies spaced from the axis of rotation, the at least two projecting bodies projecting radially outward from the brake element,
wherein the housing includes at least four attachment locations, the at least two projecting bodies being securable to a first set of the at least four attachment locations or to a second set of the at least four attachment locations, the second set not including any attachment location of the first set, and
wherein the at least four attachment locations are disposed such, that when the at least two projecting bodies are secured to the first set of the at least four attachment locations, the axis of rotation is in a first position, and when the at least two projecting bodies are secured to the second set of the at least four attachment locations, the axis of rotation is in a second position offset from the first position by 15 mm or less.

17. The gear assembly according to claim 15, wherein the end of the gear shaft is supported in a bearing element in the cylindrical receiving portion.

18. The gear assembly according to claim 16, wherein the at least two projecting bodies and the at least four attachment locations are configured such that the cylindrical receiving portion must be rotated and translated to move the at least two projecting bodies from the first set of the at least four attachment locations to the second set of the at least four attachment locations.
